(19) United States
(12) Patent Application Publication
(10) Pub. No.: US 2026/0018010 A1
(43) Pub. Date: Jan. 15, 2026

(54) MEDIUM HANDLING APPARATUS AND MEDIUM HANDLING SYSTEM

(71) Applicant: GLORY LTD., Hyogo (JP)

(72) Inventors: Yasushi KIMURA, Hyogo (JP); Shoutaro FUJII, Hyogo (JP)

(21) Appl. No.: 18/769,479

(22) Filed: Jul. 11, 2024

(51) Int. Cl. G07D 11/13; B65H 29/50; G07D 11/23

(52) U.S. Cl. CPC G07D 11/13; B65H 31/12; B65H 33/16; G07D 11/23; G07D 11/60; B65H 2701/1912; G07D 2211/00

(57) ABSTRACT

A medium handling apparatus according to the present disclosure comprises: a conveyor that transports media; recognition circuitry that recognizes the media transported by the conveyor; a safe that comprises disposed therein an internal storage configured to store the media; a discharge port that discharges the media to an external storage disposed outside the safe and configured to store the medium; and an attachment configured to connect the external storage with the discharge port, in which the external storage is any one of a plurality of the external storages having external shapes different to each other.

### TECHNICAL FIELD

The present disclosure relates to a medium handling apparatus and a medium handling system both capable of accepting valuable media and performing predetermined processing on the valuable media.

### BACKGROUND ART

Medium handling apparatuses have been developed that accept, recognize, and store valuable media such as banknotes and coins. A medium handling apparatus may use an external storage disposed outside the safe provided in the medium handling apparatus, as a configuration for storing media in addition to an internal storage inside the safe.

### SUMMARY

A medium handling apparatus according to an aspect of the present disclosure comprises: a conveyor that transports a medium; recognition circuitry that recognizes the medium transported by the conveyor; a safe that comprises an internal storage disposed therein, the internal storage being configured to store the medium; a discharge port that performs discharging of the medium to an external storage, the external storage being disposed outside the safe and configured to store the medium; and an attachment configured to connect the external storage with the discharge port, wherein the external storage is any one of a plurality of the external storages having external shapes different to each other.

### BRIEF DESCRIPTION OF DRAWINGS

FIG. 1 is a block diagram illustrating an exemplary configuration of a medium handling system;

FIG. 2 is an external perspective view of a medium handling apparatus;

FIG. 3 is a schematic cross-sectional view of the medium handling apparatus in the front-rear direction;

FIG. 4A illustrates a state in the middle of a process of attaching an external storage to the medium handling apparatus by using a mounting unit, and FIG. 4B illustrates a state after the external storage is attached to the medium handling apparatus by the mounting unit;

FIG. 5 is a functional block diagram illustrating the functional configuration of the medium handling apparatus;

FIG. 6A is a functional block diagram of the external storage serving as a cassette not comprising a second bag therein, and FIG. 6B is a schematic diagram illustrating an exemplary external shape of the cassette serving as the external storage;

FIG. 7 is a diagram for explaining the external storage that is a first bag;

FIG. 8A is a schematic cross-sectional view of the external storage that is a cassette comprising the second bag therein, and FIG. 8B is a functional block diagram of the external storage, which is a cassette comprising the second bag therein;

FIG. 9 is a flowchart illustrating an exemplary behavior during collecting banknotes;

FIG. 10 is a flowchart illustrating an exemplary behavior during replenishment with banknotes; and

FIG. 11 illustrates an exemplary hardware configuration of the medium handling apparatus serving as a computer.

### DESCRIPTION OF EMBODIMENTS

One example of the external storage is a cassette, which has a hard body and is relatively secure. Another example of the external storage is a bag, which has a larger capacity than a cassette and is easier to handle.

There is a demand for using a plurality of types of external storages to be attached to a medium handling apparatus in accordance with the application.

An object of the present disclosure is to provide a medium handling apparatus and a medium handling system that can flexibly operate a plurality of types of external storage.

A medium handling apparatus according to the present disclosure comprises: a conveyor that transports media; recognition circuitry that recognizes the media transported by the conveyor; a safe that comprises an internal storage disposed therein, the internal storage being configured to store the media; a discharge port that performs discharging of the media to an external storage, the external storage being disposed outside the safe and configured to store the media; and an attachment configured to connect the external storage with the discharge port, wherein the external storage is any one of a plurality of the external storages having external shapes different to each other.

Such a configuration allows the medium handling apparatus according to one aspect of the present disclosure to attach external storages having various external shapes. Such a configuration allows the medium handling apparatus according to an aspect of the present disclosure to be used in a variety of operating methods that use external storages.

According to the medium handling apparatus of one aspect of the present disclosure, the external storage is a cassette or a bag formed of a material softer than that of the cassette. In addition, the first bag has a capacity greater than that of the cassette.

Such a configuration allows the medium handling apparatus according to an aspect of the present disclosure to attach, as an external storage, either a cassette capable of storing and feeding valuable media, or a first bag made of a material softer than that of the cassette and having a larger capacity than the cassette. Therefore, a variety of operations that use these external storages are possible.

According to the medium handling apparatus of one aspect of the present disclosure, the external storage is the cassette comprising a second bag formed of a material softer than that of the cassette, the second bag being disposed in the cassette.

Such a configuration allows collection of banknotes in the second bag as the external storage, which is attached inside the cassette and is made of a soft material.

According to the medium handling apparatus of one aspect of the present disclosure, the cassette comprises a stage that supports a bottom of the second bag.

Such a configuration allows banknotes to be stored inside the second bag in a stacked state, in the case of a cassette comprising a second bag inside, by supporting the bottom of the second bag with the stage.

According to the medium handling apparatus of one aspect of the present disclosure, the cassette further comprises a storage amount sensor that detects an amount of the medium discharged from the discharge port and stored in the second bag, and a motor that moves the stage based on the amount detected.

Such a configuration allows the stage to be moved in accordance with the amount of banknotes stored in the second bag.

According to the medium handling apparatus of one aspect of the present disclosure, the cassette further comprises receiving circuitry that acquires control information from the medium handling apparatus, and a motor that moves the stage in accordance with the control information. The medium handling apparatus generates, while the cassette is attached to the attachment, the control information for moving the stage based on an accumulation mode and an amount of the media discharged from the discharge port.

The accumulation mode include a stacking mode and a free fall mode. In the stacking mode, the stage is controlled to move gradually away from the opening portion of the second bag in accordance with the amount of banknotes stored in the second bag. In the free fall mode, the stage is disposed at a position as far away as possible from the opening portion of the second bag in advance so that banknotes fall freely into the second bag. Such a configuration allows for selection between an operation in which a stage is moved in accordance with the amount of banknotes stored in the second bag, and an operation in which the stage is positioned as far away as possible from the opening portion of the second bag in advance.

According to the medium handling apparatus of one aspect of the present disclosure, the attachment is configured to directly connect the discharge port with an opening portion of the first bag so that the medium discharged from the discharge port flows into the first bag through the opening portion of the first bag.

When the first bag is used as the external storage, such a configuration allows the first bag to be attached more easily than when a cassette is used as the external storage.

The medium handling apparatus of one aspect of the present disclosure further comprises a processor that sets a maximum amount of the media to be discharged from the discharge port to the external storage based on whether the external storage attached to the attachment is the cassette or the bag.

Such a configuration allows the medium handling apparatus to automatically set the maximum amount without the user of the medium handling apparatus having to perform an operation to specify the maximum amount.

The medium handling apparatus of one aspect of the present disclosure further comprises a user interface that generates information regarding the external shape of the external storage attached to the attachment. The processor sets the maximum amount based on the information acquired from the user interface.

Such a configuration allows a user to set the maximum amount appropriately.

According to the medium handling apparatus of one aspect of the present disclosure, the processor stops the discharging of the medium from the discharge port when the amount of the medium discharged from the discharge port reaches the maximum amount.

Such a configuration allows prevention of discharge of an excess amount of banknotes that cannot be stored in the external storage.

The medium handling apparatus of one aspect of the present disclosure further comprises a user interface that receives an instruction to perform the discharging of the media from the discharge port. The processor starts the discharging when the user interface receives the instruction.

Such a configuration allows a user to perform discharging of banknotes at any desired timing.

According to the medium handling apparatus of one aspect of the present disclosure, the processor controls a discharge speed of the medium from the discharge port based on whether the external storage attached to the attachment is the cassette or the bag.

Such a configuration allows banknotes to be discharged at a speed according to the type of the external storage.

The medium handling apparatus of one aspect of the present disclosure further comprises a user interface that receives an instruction to perform the discharging of the media to the external storage. The conveyor transports the media stored in the internal storage to the discharge port based on the instruction.

Hereinafter, each embodiment of the present disclosure will be described in detail with reference to the drawings.

### Overall Configuration of Medium Handling System

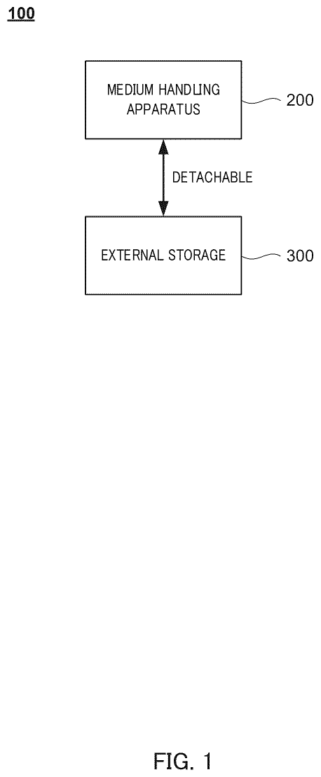

FIG. 1 is a block diagram illustrating an exemplary configuration of a medium handling system 100. As illustrated in FIG. 1, the medium handling system 100 comprises a medium handling apparatus 200 and an external storage 300.

The medium handling apparatus 200 is an apparatus that can accept, recognize, transport, and perform various processing on valuable media. In the following description the medium handling apparatus 200 handles a banknote, as an example, as a valuable medium. However, valuable media in the present disclosure are not limited to banknotes, and examples thereof include stock certificates, various securities, bills, checks, and other valuable securities, in addition to banknotes and coins.

The medium handling apparatus 200 is installed in, for example, financial institutions such as banks, retail stores, and public facilities such as train stations and government offices.

As described below, the medium handling apparatus 200 comprises a safe 260 comprising an internal storage 270 disposed therein for storing banknotes. The medium handling apparatus 200 is configured to detachably attach the external storage 300, which is disposed outside the safe 260.

The external storage 300 is attached to the medium handling apparatus device 200 and used for, for example, collecting banknotes handled by the medium handling apparatus 200 and transferring the banknotes to a financial institution or the like, or replenishing the medium handling apparatus 200 with banknotes from a financial institution or the like. At the time of the collecting, the external storage 300 that stores the collected banknote from the medium handling apparatus 200 is removed from the medium handling apparatus 200 by, for example, a cash in transit (CIT) and collected by the CIT. At the time of the replenishing, the external storage 300 storing banknotes for replenishment is attached to the medium handling apparatus 200, for example, by the CIT, thereby replenishing the medium handling apparatus 200 with the banknotes stored in the external storage 300.

The manner in which the medium handling system 100 is used is not limited to the manner in which the external storage 300 is transferred by the CIT. For example, a bank clerk or a retail store employee may use the external storage 300 to perform their duties.

In the present disclosure, the external storage 300 to be attached to the medium handling apparatus 200 is any one of a plurality of types of external storages 300 having external shapes different to each other. Examples of the plurality of different types of external storages 300 having different external shapes include cassettes and bags. When a cassette is used as the external storage 300, it is possible to handle both the process of replenishing the medium handling apparatus 200 with banknotes from the external storage 300 and the process of collecting banknotes from the medium handling apparatus 200 to the external storage 300. However, when a bag is used as the external storage 300, it is not possible to replenish the medium handling apparatus 200 with banknotes from the external storage 300. Therefore, a user can appropriately select which type of external storage 300 to use depending on the application such as refilling or collecting. In the present embodiment, a user is a person who performs operations such as depositing or withdrawing banknotes into the medium handling apparatus 200, such as a CIT representative, an employee of a retail store, a financial institution, or a public facility, for example.

When the external storage 300 is a cassette, the following configuration is also possible: a bag made of a material softer than the body of the cassette is stored inside the cassette, and this bag stores the banknotes.

When the external storage 300 is a cassette and no bag is attached inside the cassette, the cassette may include a storage mechanism such as a tape type mechanism in its inside.

Herein, a bag that is not stored inside a cassette and is used independently of the cassette is referred to as a first bag. Herein, a bag that is stored inside a cassette and used is referred to as a second bag as described above. The capacity of the first bag (the amount of banknotes that can be stored) may be greater than the capacity of the cassette. Depending on the application, the capacity of the first bag (the amount of banknotes that can be stored) may be smaller than the capacity of the cassette. The second bag can be formed in such a way that the second bag has a capacity within the volume range of the cassette.

When the external storage 300 is a cassette and no second bag is attached thereto, the external storage 300 may be configured to allow banknotes to be fed from its inside.

When the external storage 300 is a cassette, the external storage may be referred to as a secure transfer cassette (STC) or the like.

The external shape of a first bag can take various external shapes. The external shape of the external storage 300 differs depending on whether the external storage 300 is a cassette (including a case in which a second bag is stored therein) or the external storage 300 is a first bag. The external shape of the cassette (the external storage 300) differs from the external shape of a first bag (the external storage 300). For example, the first bag may be folded into a plate shape before banknotes are stored therein.

The cassette is made of, for example, resin. The first and second bags are made of a material softer than the cassette, for example, resin, metal or cloth. The cassette has greater strength than the first and second bags. The cassette is a rigid body whose appearance does not substantially deform when in use, and the first and second bags are flexible and deformable bags.

In the present disclosure, regardless of whether the external storage 300 is a cassette or a first bag, the external storage can be attached to the medium handling apparatus 200 by using an attachment 282 described below. In other words, the medium handling apparatus 200 is configured in such a way that any one of a plurality of types of external storages 300 having external shapes different to each other can be attached. The attachment 282 is configured to connect the external storage 300 with a discharge port 230 through which the medium handling apparatus 200 discharges banknotes. Connecting the external storage 300 with the discharge port 230, through which the medium handling apparatus 200 discharges banknotes, means that the external storage 300 is attached to the medium handling apparatus 200 so that banknotes discharged from the discharge port 230 of the medium handling apparatus 200 are stored inside the external storage 300.

The medium handling apparatus 200 can store banknotes in the external storage 300 which is selectively attached to the medium handling apparatus 200 from a plurality of different types of external storages 300. In other words, the medium handling apparatus 200 can store banknotes in the external storage 300 which is selectively attached to the medium handling apparatus 200 from a plurality of different external shapes of external storages 300. It may also be possible to receive banknotes from the external storage 300 while the external storage 300 is attached. This configuration enables variety of operations using, for example, the medium handling apparatus 200 and the external storage 300.

A specific example will be given for explanation. For example, when a CIT collects banknotes, the CIT may collect banknotes from a plurality of medium handling apparatuses 200 in a plurality of stores. A CIT typically performs the collection by using a cassette as the external storage 300. However, a collection method other than using a cassette (i.e., collection using a bag) may be more desirable from the viewpoint of business efficiency, management, and the like. For example, in place of a cassette, a first bag having a larger capacity than a cassette may be used as the external storage 300 to perform the collection operation. In this case, when a first bag (the external storage 300) having a larger storage capacity than the cassette is used as the external storage 300, a large number of banknotes can be collected at one time. Also, from the viewpoint of business efficiency, management, and the like, a second bag may be attached to the cassette (which is the external storage 300) to perform the collection operation.

In this way, the user can arbitrarily select from a variety of operating methods when using the medium handling system 100. As described above, the various operating methods refer to operating methods that use any of the cassette serving as the external storage, the first bag serving as the external storage, and the second bag attached inside the cassette serving as the external storage. That is, the medium handling system 100 can operate under the conditions where either the cassette as the external storage 300, the first bag as the external storage 300, or the second bag as the external storage 300 is used.

As described above, the medium handling system 100 disclosed in the present disclosure is particularly advantageous because a plurality of types of storages can be used as the external storage 300 in a single medium handling apparatus 200. Furthermore, by using a first bag that is lighter than a cassette as the external storage 300, the burden on the CIT when moving around with banknotes stored in the first bag can be reduced.

As described below, when a first bag is used as the external storage 300, it is easier to attach the external storage to or remove the external storage from the medium handling apparatus 200 than when a cassette is used. Therefore, when the first bag is used to collect banknotes from the medium handling apparatuses 200, the amount of time required for collection can be reduced. This will ultimately reduce the burden on the CIT.

The following describes the medium handling apparatus 200 and the external storage 300 in detail.

### Overall Configuration of Medium Handling Apparatus 200

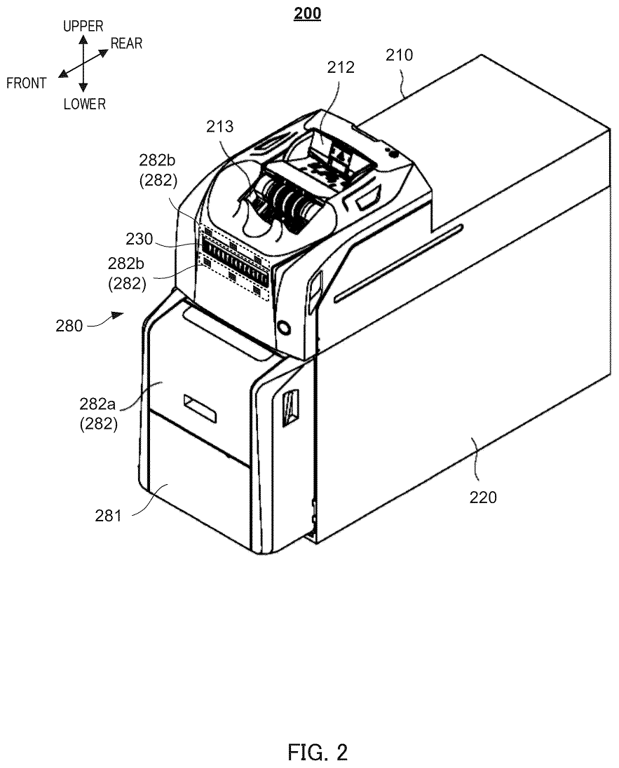

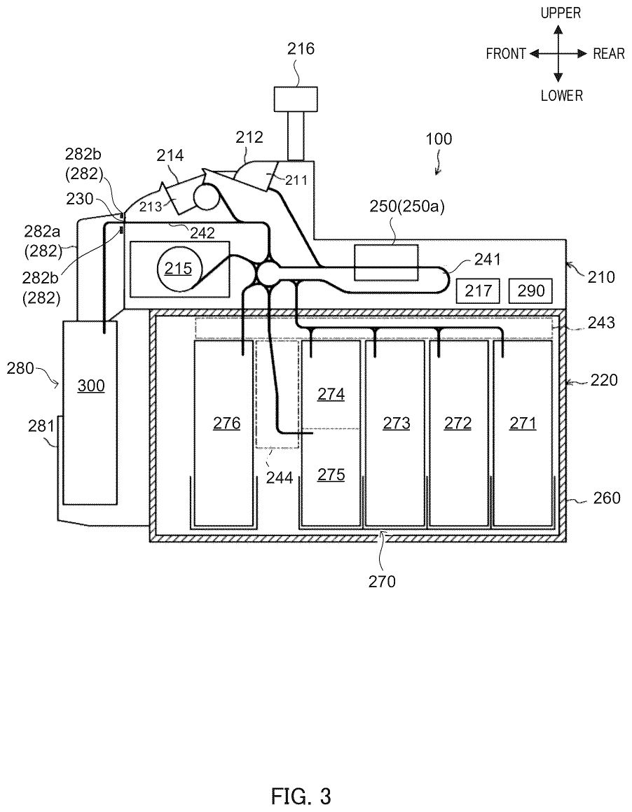

The medium handling apparatus 200 illustrated in FIGS. 2 and 3 comprises an upper housing 210 and a lower housing 220 disposed on the lower side compared to the upper housing 210.

In the following description with reference to FIGS. 2 and 3, the side to which the external storage 300 is to be attached is the front side of the medium handling apparatus 200 and the side opposite to the attached side is the rear side of the medium handling apparatus 200. The upper and lower sides of the medium handling apparatus 200 correspond to the upper and lower sides, respectively, when the medium handling apparatus 200 is installed on the floor in a normal usage mode.

Disposed inside the upper housing 210 are a deposit unit 211, an inlet 212, a withdrawal unit 213, an outlet 214, a temporary holding unit 215, a UI 216, a memory 217, the discharge port 230, a loop conveyor 241, a connection conveyor 242, recognition circuitry 250, and a processor 290. The loop conveyor 241 and the connection conveyor 242 are part of a conveyor 240. The processor 290 controls the behavior of each component of the medium handling apparatus 200.

The lower housing 220 is provided with a safe 260. A plurality of internal storages 270, a first lower conveyor 243, and a second lower conveyor 244 are disposed in the safe 260. The plurality of internal storages 270 disposed inside the safe 260 are exemplary internal storages of the present disclosure. The first lower conveyor 243 and the second lower conveyor 244 are part of the conveyor 240.

The safe 260 is, for example, a safe made of a metal plate of a predetermined thickness. The safe 260 is constructed based on a predetermined standard. The safe 260 protects a plurality of internal storages 270 at a predetermined or higher security level.

The plurality of internal storages 270 are disposed inside safe 260. The internal storage 270 is, for example, a stack type storage or a tape type storage. A stack type storage stores a plurality of banknotes in a stacked manner. A tape type storage stores a plurality of banknotes by winding a tape around a drum with the banknotes held on the tape. The plurality of internal storages 270 may be configured from only stack type storages, only tape type storages, or a combination of both.

The plurality of internal storages 270 may all be fixed in the interior of the safe 260, or at least one of the plurality of internal storages 270 may be a cassette that is removable from the safe 260.

In the example illustrated in FIG. 3, internal storages 271 to 276 are provided. The memory 217 in the medium handling apparatus 200 stores in advance setting information that indicates which denomination of banknotes is to be stored in which storage (either one of the internal storages 271 to 276 or the external storage 300). The setting information may be set via the UI 216 by, for example, an administrator of the medium handling system 100 or the medium handling apparatus 200. The medium handling apparatus 200 transports the received medium to either one of the internal storages 271 to 276 or the external storage 300 based on the settings information.

Each internal storage 270 comprises a transport mechanism. The transport mechanism is connected to the first lower conveyor 243 or the second lower conveyor 244. The transport mechanism allows storing of banknotes from the first lower conveyor 243 or the second lower conveyor 244 into the plurality of internal storages 270, or feeding of banknotes from the plurality of internal storages 270 to the first lower conveyor 243 or the second lower conveyor 244.

The medium handling apparatus 200 comprises a mounting unit 280 that can attach a cassette, which is the external storage 300, to the outside of the safe 260. The mounting unit 280 is located outside the safe 260.

With the external storage 300 attached to the mounting unit 280, the medium handling apparatus 200 can cause a banknote stored in any one of the internal storages 270 to be stored in the external storage 300. In addition, the medium handling apparatus 200 may be configured so that a banknote stored in the external storage 300 can be taken into the medium handling apparatus 200 to be stored in the internal storage 270.

The deposit unit 211 is a portion where the user places banknotes to be deposited into the medium handling apparatus 200. The deposit unit 211 comprises the inlet 212. The inlet 212 opens upward, for example, at the front portion of the upper housing 210.

The deposit unit 211 holds one or more banknotes in a stacked state. The deposit unit 211 has a mechanism for taking in banknotes one by one into the medium handling apparatus 200.

The withdrawal unit 213 is a portion to which banknotes fed from the internal storage 270 or the external storage 300 are transported, for example, during dispensing processing. The withdrawal unit 213 can hold one or more banknotes in a stacked state. The withdrawal unit 213 comprises the outlet 214. The outlet 214 opens upward in the upper housing 210, for example, on the front side compared to the inlet 212. A user can take out banknotes accumulated in the withdrawal unit 213 through the outlet 214. The outlet 214 may comprise a shutter that opens and closes.

The temporary holding unit 215 temporarily stores banknotes that have been received by the deposit unit 211 and are yet to be stored in the internal storage 270 or the external storage 300. The temporary holding unit 215 also temporarily stores banknotes fed from the internal storage 270 before the banknote are transported to the withdrawal unit 213. The temporary holding unit 215 also temporarily stores banknotes replenished from the external storage 300 before the banknotes are transported to any one of the internal storages 270. The temporary holding unit 215 is, for example, a stack type storage or a tape type storage.

The temporary holding unit 215 is disposed, for example, on the lower side compared to the connection conveyor 242. When the temporary holding unit 215 is a tape type storage, an advantage such that the order of banknotes is not changed when the banknotes are stored or fed at the temporary holding unit 215 can be provided.

The user interface (UI) 216 is an interface that links a user or administrator with the medium handling apparatus 200. The UI 216 comprises at least one of, for example, input receiving devices such as a button, a keyboard, a mouse, a trackball, and a touch pad, a display device such as a display, and an audio output device such as a speaker.

The memory 217 stores various types of data related to the behavior of the medium handling apparatus 200.

The recognition circuitry 250 is disposed in a recognition sensor 250a. The recognition circuitry 250 is disposed in a portion of the loop conveyor 241. The recognition circuitry 250 recognizes a banknote transported along the loop conveyor 241. The recognition circuitry 250 recognizes the denomination, authenticity, and fitness of a banknote by acquiring, for example, at least one of an image of the surface of the banknote and magnetic information of the banknote.

Inside the medium handling apparatus 200, the conveyor 240 transports a plurality of banknotes one by one with intervals between the banknotes. The conveyor 240 is configured, for example, by a combination of multiple rollers, a plurality of belts, a motor for driving these components, and a plurality of guides.

The conveyor 240 comprises the loop conveyor 241, the connection conveyor 242, the first lower conveyor 243, and the second lower conveyor 244. The loop conveyor 241 and the connection conveyor 242 are disposed in the upper housing 210. The first lower conveyor 243 and the second lower conveyor 244 are disposed in the safe 260. Between the upper housing 210 and the safe 260, at least one transport path connecting the loop conveyor 241 with the first lower conveyor 243 is disposed so as to pass through the walls of the upper housing 210 and the safe 260 in the vertical direction.

The loop conveyor 241 is formed in a loop shape. Transport paths are respectively provided between the loop conveyor 241 and the deposit unit 211, the loop conveyor 241 and the withdrawal unit 213, and the loop conveyor 241 and the temporary holding unit 215.

A banknote is transported along the loop conveyor 241 in a clockwise or counterclockwise direction in FIG. 3.

The connection conveyor 242 connects the loop conveyor 241 with the discharge port 230. When the external storage 300 is attached to the medium handling apparatus 200, the connection conveyor 242 transports banknotes to be discharged to the external storage 300. In addition, when the medium handling apparatus 200 is replenished with banknotes from the external storage 300, the banknotes from the external storage 300 are transported to the loop conveyor 241.

The first lower conveyor 243 is disposed on the upper side compared to the plurality of internal storages 270. The first lower conveyor 243 is disposed so as to extend in the front-rear direction of the medium handling apparatus 200. A separate transport path is individually disposed between the first lower conveyor 243 and each internal storage 270.

The second lower conveyor 244 is disposed so as to extend downward from the first lower conveyor 243. In the example illustrated in FIG. 3, the second lower conveyor 244 connects the internal storage 275, which is located at the lower side among the internal storages 274 and 275 stacked vertically, with the first lower conveyor 243.

The configuration of the storages in the medium handling apparatus 200 illustrated in FIG. 3 is merely an example. In the present disclosure, the number and arrangement of the storages housed in the safe housing, as well as the structure of each storage, are not limited to the example illustrated in FIG. 3.

A sensor such as a passing sensor for detecting the passage of a banknote and a timing sensor for detecting the edge of a banknote may be disposed at each of the loop conveyor 241, the connection conveyor 242, the first lower conveyor 243, and the second lower conveyor 244. A below-described processor 290 controls the conveyor 240 to transport a banknote to a desired destination via the loop conveyor 241, the connection conveyor 242, the first lower conveyor 243, and the second lower conveyor 244 based on detection signals from the passage sensor and timing sensor.

With the external storage 300 attached to the medium handling apparatus 200, the discharge port 230 discharges banknotes transported by the connection conveyor 242 to the external storage 300. The discharge port 230 discharges banknotes into a cassette, a first bag, or a second bag within the cassette.

When the external storage 300 is a cassette, the discharge port 230 is connected to an opening 301 of the external storage 300 by an attachment 282 (a first attachment 282a) of the mounting unit 280. When the external storage 300 is the first bag, the discharge port 230 faces an opening portion 312 of the first bag.

The discharge port 230 may have a function of accepting, into the medium handling apparatus 200, banknotes sent out from a cassette (external storage unit 300) that has a function of feeding out banknotes toward the medium handling apparatus 200.

The mounting unit 280 will be described in detail. The mounting unit 280 comprises a support portion 281 and the attachment 282.

The attachment 282 is configured to attach any one of external storages 300 having external shapes different to each other so that the discharge port 230 and the external storage 300 are connected to each other. As a specific example, the attachment 282 is composed of a first attachment 282a for attaching a cassette serving as the external storage 300 to the medium handling apparatus 200, and a second attachment 282b for attaching a first bag serving as the external storage 300 to the medium handling apparatus 200 (see FIGS. 2 and 3). The first attachment 282a and the second attachment 282b may be formed of different members, or may be formed of the same member.

For attaching a cassette (which is the external storage 300) or a cassette (which is the external storage 300 with a second bag attached thereto) to the medium handling apparatus 200, the first attachment 282a is used to connect the cassette to the discharge port 230 of the medium handling apparatus 200. The cassette is connected with the discharge port 230 of the medium handling apparatus 200 via the first attachment 282a. The first attachment 282a comprises a transport path in its inside, so that banknotes can transported between the external storage 300 and the discharge port 230.

For attaching the first bag to the medium handling apparatus 200, the second attachment 282b is used. The second attachment 282b connects the first bag to the discharge port 230 of the medium handling apparatus 200. The first bag and the discharge port 230 of the medium handling apparatus 200 are connected to each other by hooking the attachment holes 313 of the first bag onto the second attachment 282b.

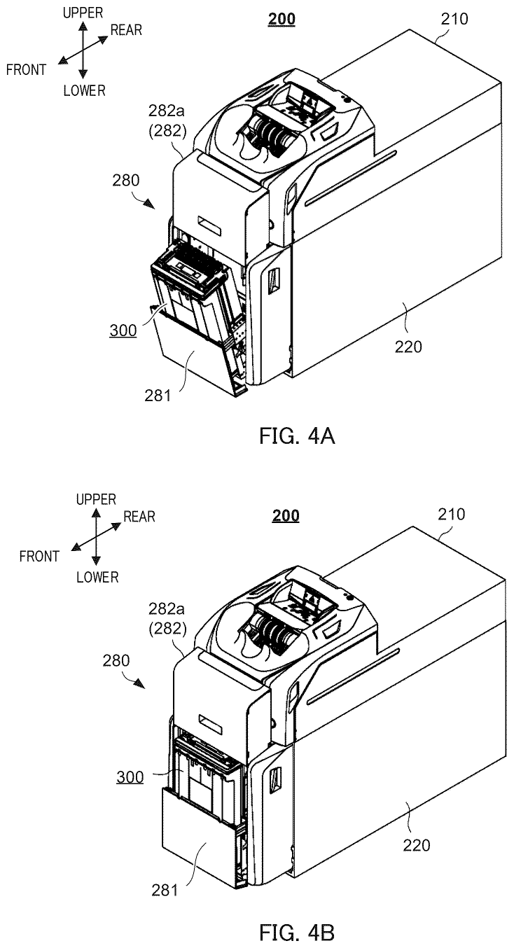

The first attachment 282a changes its shape depending on the application. Specifically, when the external storage 300 is a cassette, the first attachment 282a moves to an upper position (the position illustrated in FIG. 4A and FIG. 4B) so that the discharge port 230 and the external storage 300 can be connected to each other. As illustrated in FIG. 4A, when the cassette (the external storage 300) is to be mounted on the mounting unit 280, the first attachment 282a is moved to the upper position. For mounting the cassette (the external storage 300) on the mounting unit 280, the support portion 281 is tilted forward. In this state, the support portion 281 allows mounting of the cassette (the external storage 300). After the mounting of the cassette (the external storage 300) is completed, the support portion 281 is returned to the rear side to hold the external storage 300 (FIG. 4B).

On the other hand, for attaching the first bag (the external storage 300) to the apparatus, the first attachment 282a moves to a lower position (the position illustrated in FIG. 2) so that the opening portion 312 of the first bag can cover the discharge port 230. The second attachment 282b holds the first bag (the external storage 300) so that the opening portion 312 of the first bag (the external storage 300) and the discharge port 230 of the medium handling apparatus 200 are connected to each other.

The second attachment 282b is formed, for example, in a protrusion shape. The second attachment 282b may be a hook (see FIG. 2). A plurality of second attachments 282b are disposed around the discharge port 230. In addition, the second attachment 282b may be a clamp that can clamp and hold a member near the opening portion of the first bag. Another example of the second attachment 282b may be as follows: a reinforcing frame material is adhered to the opening portion of the first bag, and the first bag is attached by hooking the frame material onto the second attachment 282b. The first bag may be attached to the medium handling apparatus 200 by hooking the second attachments 282b into holes provided in the frame material.

The first attachment 282a, which moves for attaching the cassette of the external storage 300, comprises a recess formed therein so as to fit the protrusion of the second attachment 282b (see FIG. 3). Thereby, when moving the first attachment 282a to the upper position (which is illustrated in FIG. 4A and FIG. 4B), interference between the first attachment 282a with the second attachment 282b can be avoided.

As described above, the first attachment 282a and the second attachment 282b allow the external storage to be attached to the medium handling apparatus 200 regardless of whether the external storage is a cassette or a bag.

While the attaching of a cassette by using the first attachment 282a requires tilting the upper end of the support portion 281 and inserting the cassette as illustrated in FIG. 4, the attaching by using the second attachment 282b is a simple movement such as hooking a protrusion or a hook into a hole of the first bag or clamping a member near the opening portion of the first bag with a clamp. As a result, when the first bag is used as the external storage 300, the operation time during collection can be reduced.

### Functional Configuration of Medium Handling Apparatus 200

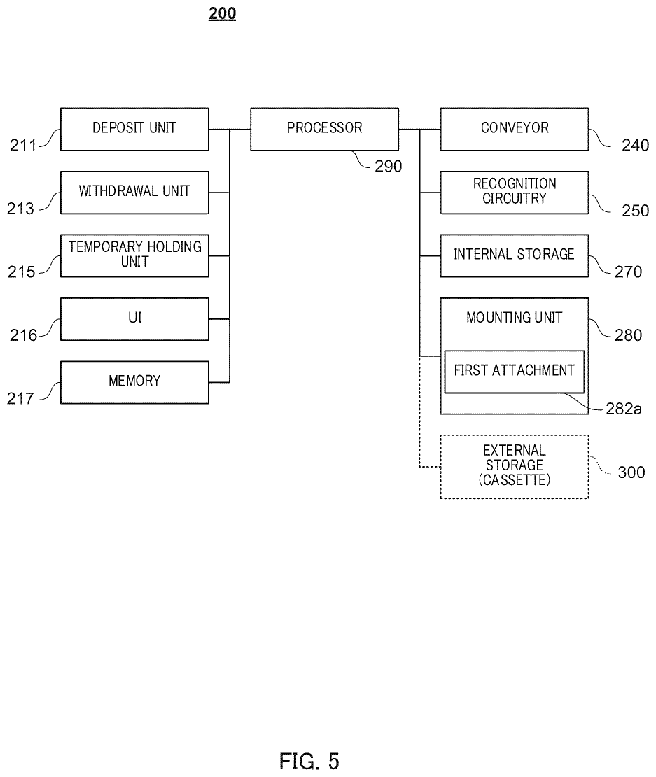

FIG. 5 is a functional block diagram of the medium handling apparatus 200. The medium handling apparatus 200 comprises the processor 290, for example, a central processing unit (CPU). The medium handling apparatus 200 comprising the processor 290 is an example of a computer.

To the processor 290, the deposit unit 211, the withdrawal unit 213, the temporary holding unit 215, the UI 216, the memory 217, the conveyor 240, the recognition circuitry 250, the internal storage 270, and the mounting unit 280 are communicably connected. When the external storage 300 is mounted on the mounting unit 280, the external storage 300 may also be communicably connected to the processor 290.

The processor 290 executes various processing in response to operations by a user or administrator on the operation unit 26. More specifically, the processor 290 controls the deposit unit 211, the withdrawal unit 213, the temporary holding unit 215, the UI 216, the conveyor 240, the recognition circuitry 250, the internal storage 270, and the mounting unit 280, according to the operation content. An example of the behavior of the medium handling apparatus 200 implemented by the processing by the processor 290 will be described below.

### External Storage 300

The following describes the external storage 300. The external storage 300 is a cassette, a first bag, or a cassette with a second bag disposed therein.

### Case of Cassette not Comprising Second Bag

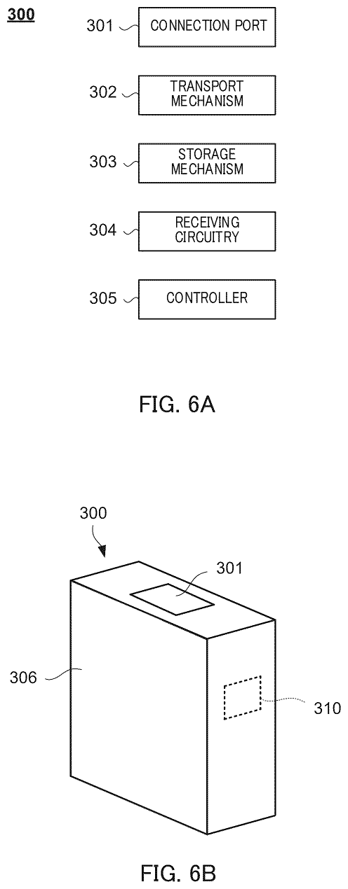

FIGS. 6A and 6B are diagrams for explaining the external storage 300 that is a cassette not comprising a second bag therein. FIG. 6A is a functional block diagram of the external storage 300, which is a cassette not comprising a second bag therein, and FIG. 6B is a schematic diagram illustrating an exemplary external shape of the cassette serving as the external storage 300.

FIGS. 6A and 6B illustrate an external storage 300, which is a cassette not comprising a second bag therein. However, the cassette illustrated in FIGS. 6A and 6B may be configured to accommodate both a way in which banknotes are stored in the cassette with a bag attached thereto, and a way in which banknotes are stored directly in the cassette without a bag attached thereto.

As illustrated in FIG. 6A, the cassette serving as the external storage 300 comprises the opening 301, the transport mechanism 302, a storage mechanism 303, receiving circuitry 304, and a controller 305.

The opening 301 is formed on the outer surface of the cassette. The transport mechanism 302 transports banknotes between the opening 301 and the storage mechanism 303. The storage mechanism 303 has a mechanism for storing banknotes. The storage mechanism 303 has, for example, a stack type or tape type mechanism.

The receiving circuitry 304 is a circuit that receives control signals from the medium handling apparatus 200 while the cassette serving as the external storage 300 is attached to the medium handling apparatus 200. The receiving circuitry 304 may receive a control signal from the medium handling apparatus 200 via wired or wireless communication.

The controller 305 controls the behavior of the transport mechanism 302 and the storage mechanism 303 based on control signals received from the medium handling apparatus 200 by the receiving circuitry 304. As a specific example, when a control signal is received from the medium handling apparatus 200 to perform control to accept discharged banknotes, the controller 305 causes the transport mechanism 302 to transport the banknotes accepted from the opening 301 to the storage mechanism 303, and causes the storage mechanism 303 to stores the banknotes. When a control signal is received from the medium handling apparatus 200 to perform control to replenishment with banknotes stored in the storage mechanism 303, the controller 305 causes the storage mechanism 303 to feed the banknotes and causes the transport mechanism 302 to transport the banknotes to the opening 301.

In the example illustrated in FIG. 6B, the external shape of the case 306 is a rectangular parallelepiped. A storage amount sensor 310 is disposed at the cassette, which is the external storage unit 300, for detecting when the cassette is full of stored banknotes. The storage amount sensor 310 is, for example, an optical sensor.

In the example illustrated in FIG. 6A, each component of the external storage 300 moves under the control of the controller 305. However, for example, the external storage 300 does not have to comprise the controller 305. In this case, each component of the external storage 300 may move based on the control signal received by the receiving circuitry 304 from the medium handling apparatus 200.

### Case of First Bag

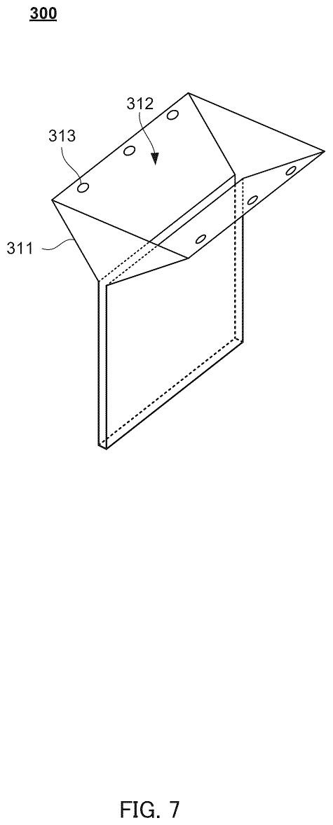

FIG. 7 is a diagram for explaining the external storage 300 that is a first bag.

The first bag serving as the external storage 300 comprises a bag body 311, the opening portion 312, and attachment holes 313. The bag body 311 constitutes the external shape of the first bag. The opening portion 312 is an opening (entrance) for putting banknotes into the inside of the first bag. The mounting holes 313 are provided in the bag body 311 around the opening portion 312.

The bag body 311 is configured to expand as banknotes flow into the bag body 311.

Case of Cassette with Second Bag to be Attached Thereto

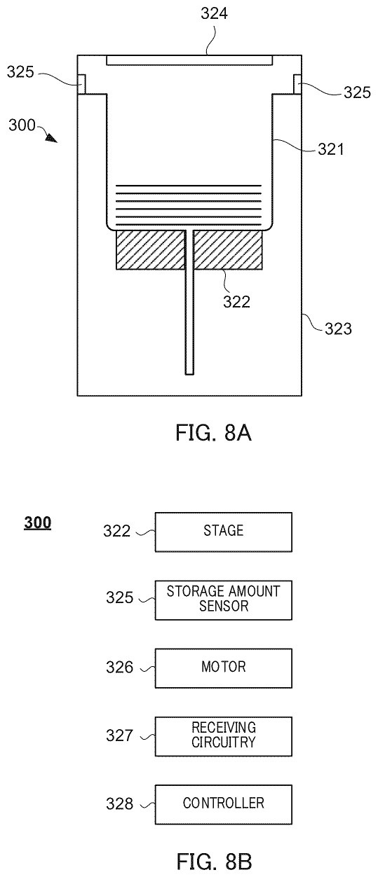

FIGS. 8A and 8B are diagrams for explaining the external storage 300 that is a cassette comprising a second bag therein. In FIGS. 8A and 8B, the external storage 300 is illustrated as a cassette not comprising a second bag therein. However, the cassette may be configured to accommodate both a way in which banknotes are stored in the cassette with a bag attached thereto, and a way in which banknotes are stored directly in the cassette without a bag attached thereto.

The cassette serving as the external storage 300 comprises a second bag 321, a stage 322, a case 323, and a connection port 324. The stage 322 supports the bottom of the second bag 321. The stage 322 is movable inside the case 323. The supporting surface of the stage 322 supporting the bottom of the second bag 321 is formed flat. As a result, the bottom of the second bag 321 supported by the stage 322 becomes flat, making it possible to stack banknotes in an orderly manner. This configuration allows a larger number of banknotes to be stored in the second bag 321 than a case in which banknotes are stored randomly in the second bag 321.

A hole is provided in the center of the stage 322, and the remaining portion of the second bag 321 is inserted into this hole. The external storage 300 of the present disclosure is not limited to this configuration, and the stage 322 does not have to comprise a hole.

The cassette serving as the external storage 300 comprises, as its functional components, the stage 322, a storage amount sensor 325, a motor 326, receiving circuitry 327, and a controller 328.

The storage amount sensor 325 counts the number (storage amount) of banknotes stored inside the second bag 321. The storage amount sensor 325 may be disposed, for example, at a place close to the connection port 324.

The motor 326 moves the stage 322 under the control of the controller 328.

The receiving circuitry 327 receives a control signal from the medium handling apparatus 200 when the cassette serving as the external storage 300 is attached to the medium handling apparatus 200.

The controller 328 may move the stage 322 based on the storage amount in the second bag 321. When no banknotes are stored in the second bag 321, the controller 328 controls the motor 326 to move the stage 322 to a position near the opening portion of the second bag 321. As the storage amount in the second bag 321 increases, the controller 328 moves the stage 322 away from the opening portion of the second bag 321. This configuration allows the bottom of the second bag to move away from the opening portion as the storage amount increases, and therefore, the actual storage amount in the second bag 321 can be increased. The stage 322 continues to support the bottom of the second bag 321 even when the stage moves, and therefore, the banknotes inside the second bag 321 are maintained in an orderly stacked state.

In addition, the controller 328 may control the motor 326 to move the stage 322 based on a preset accumulation mode of the second bag 321. The accumulation mode is a mode to set in advance how to accumulate banknotes in the second bag 321. Examples of the accumulation mode include a stacking mode and a free fall mode. The stacking mode is a mode in which the stage 322 moves as the banknotes are accumulated, whereas the free fall mode is a mode in which the stage 322 does not move as the banknotes are accumulated but is fixed at a predetermined position. As described above, the stacking mode is a mode in which the stage 322 is moved as needed according to the storage amount of banknotes inside the second bag 321. In the stacking mode, the banknotes inside the second bag 321 can be stacked in an orderly manner. In the free fall mode, the stage 322 is fixed at a position as far away as possible from the opening of the second bag 321 regardless of the storage amount of banknotes in the second bag 321. In the free fall mode, banknotes fall freely from the opening of the second bag 321 toward the inside, so that the banknotes inside the second bag 321 are stored in a random manner.

The controller 328 may set the accumulation mode based on the control information received by the receiving circuitry 327 from the medium handling apparatus 200.

In the example illustrated in FIG. 8B, the external storage 300 comprises the controller 328, and each component of the external storage 300 moves under the control of the controller 328. However, for example, the external storage 300 does not have to comprise the controller 328. In this case, each component of the external storage 300 may move based on the control signal received by the receiving circuitry 327 from the medium handling apparatus 200.

### Exemplary Behavior of Medium Handling Apparatus 200

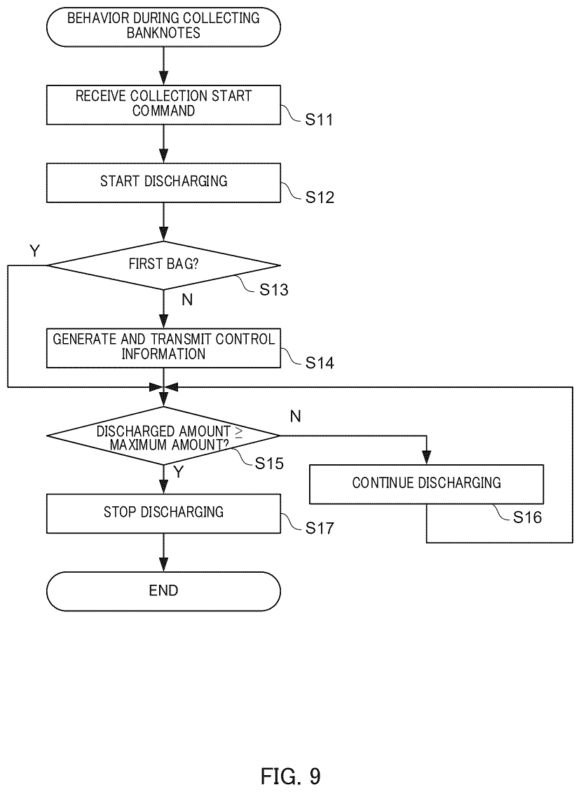

FIG. 9 is a flowchart illustrating an exemplary behavior of the medium handling apparatus 200 during collecting banknotes.

In step S11, the processor 290 receives, via the UI 216, a selection by the user of the external storage 300 to be used for collecting banknotes, and a collection start command for starting collection. The start collection command is an example of a discharge start instruction. In the exemplary behavior illustrated in FIG. 9, the following example will be described: as an external storage, one of first bag, a cassette without a second bag attached thereto, and a second bag attached in the cassette is selected for performing the collection process through the UI 216, and the selected collection process is executed. Either before or after the selection made through the UI 216, the user attaches, to the apparatus, the first bag, the cassette without a second bag attached thereto, or the cassette with the second bag attached thereto.

In step S11, the UI 216 generates information indicating the type of external storage 300 to be used for collecting banknotes based on a user operation, and the processor 290 acquires the information. The information indicating the type of the external storage 300 to be used for collecting banknotes is an example of information relating to the external shape of the external storage attached to the attachment. In addition, in step S11, the UI 216 receives the collection start command for starting collection of banknotes by the external storage 300 based on the user operation, and the processor 290 acquires the collection start command. The collection start command may comprise information indicating the amount (number) of banknotes to be discharged from medium handling apparatus 200 to the external storage 300.

In step S12, the processor 290 controls each component of the medium handling apparatus 200 to start discharge of the banknotes stored in the internal storage 270. Specifically, the processor 290 causes the internal storage 270 to feed banknotes at the amount to be discharged, and causes the conveyor 240 to start transporting of the fed banknotes to the discharge port 230.

In step S13, the processor 290 determines whether or not the external storage 300 to be used for collection is the first bag. The determination in step S13 may be made based on the information indicating the type of the external storage 300 received by the UI 216 in step S11.

In step S13, when the processor 290 determines that the external storage 300 to be used for collection is not the first bag, that is, the external storage 300 to be used for collection is the cassette without a second bag attached thereto, or the second bag attached to the cassette (step S13: NO), the processing proceeds to step S14. In step S13, when the processor 290 determines that the external storage 300 to be used for collection is the first bag (step S13: YES), the processing proceeds to step S15. In step S13, when the processor 290 does not determine that the external storage 300 to be used for collection is the first bag (step S13: No), that is, either a cassette without a second bag attached thereto or a cassette with a second bag attached thereto is used for the collection process, the processing proceeds to step S14.

In step S14, the processor 290 generates control information for controlling the cassette serving as the external storage 300. The control information comprises, for example, information on a preset accumulation mode and information for moving the stage 322 of the external storage 300. The processor 290 may generate information on the accumulation mode based on setting information preset by the user via the UI 216. In addition, the processor 290 may generate the information for moving the stage 322 based on, for example, the amount of banknotes that have been discharged to the external storage 300 up to that point and the accumulation mode. For the accumulation mode, setting by the user may be received via the UI 216 in step S11.

In step S15, the processor 290 determines whether or not the amount of banknotes discharged to the external storage 300 up to that point has reached a preset maximum amount. The maximum amount may be set by the processor 290, for example, based on the result of the determination in step S13. That is, when the external storage 300 attached to the medium handling apparatus 200 is a cassette, the processor 290 may set the maximum amount based on information regarding the amount of banknotes that the cassette can store. Information regarding the amount of banknotes that can be stored in the first bag, the cassette without a second bag attached thereto, or the second bag is, for example, stored in advance in the memory 217, and when the external storage to be used for collection is selected in step S11, banknotes at the amount (number) corresponding to the selected external storage are transported from the medium handling apparatus 200 to the external storage.

The processor 290 may set the maximum amount, for example, to a value entered by the user via the UI 216.

When it is determined in step S15 that the amount of the discharged banknotes has not reached the maximum amount (step S15: N), the processing proceeds to step S16. When it is determined in step S15 that the amount of the discharged banknotes has reached the maximum amount (step S15: Y), the processing proceeds to step S17.

In addition, in step S15, for storing banknotes directly into a cassette without a second bag attached thereto, the results detected by the storage amount sensor 310 of the cassette (see FIG. 6B) can be further taken into consideration. Furthermore, in step S15, for storing banknotes into the second bag attached to the cassette, the result detected by the storage amount sensor 325 of the cassette can be further taken into consideration. At this time, when the storage amount sensor 310 or the storage amount sensor 325 detects a full state, the processor 290 proceeds the processing to step S17. The processor 290 may report the full state detected by the storage amount sensor 310 or the storage amount sensor 325 via the UI 216.

In step S16, the processor 290 continues the discharge of banknotes to the external storage 300. After step S16, the processing returns to step S15.

In step S17, the processor 290 stops the discharge of banknotes to the external storage 300. After step S17, for example, the processor 290 may make notification via the UI 216 that the discharge of the banknotes has been completed. This configuration allows the user to take the external storage 300 (after the collection of the banknotes is completed) out from the medium handling apparatus 200 to move the external storage.

In the exemplary behavior during collecting banknotes using the external storage 300 as illustrated in FIG. 9, the processor 290 may control the discharge speed from the discharge port 230 based on whether the attached external storage 300 is a cassette or a first bag. As a specific example, when the external storage 300 is a first bag, the processor 290 may control the transport speed of the conveyor 240 to make the discharge speed faster than when the external storage 300 is a cassette. This is because the first bag can store a larger amount of banknotes than the cassette.

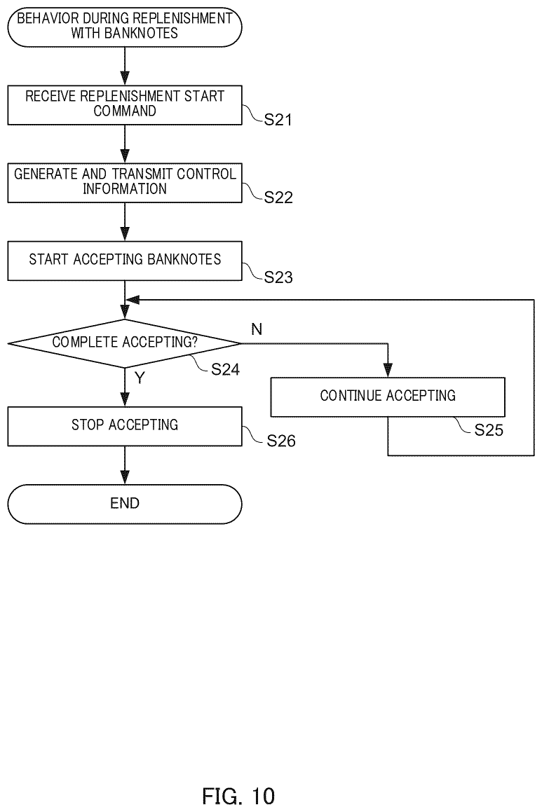

FIG. 10 is a flowchart illustrating an exemplary behavior during replenishment with banknotes. As described above, the first bag serving as the external storage 300 is not used for replenishing with banknotes; therefore, an example in which a cassette without a second bag attached thereto has already been attached as the external storage 300 by the attachment 282 (second attachment 282b) will be described in the exemplary behavior illustrated in FIG. 10.

In step S21, the UI 216 receives, from the user and via the UI 216, a replenishment start command for starting replenishment with banknotes. The replenishment start command may comprise the amount (number) of banknotes to be accepted by the medium handling apparatus 200.

In step S22, the processor 290 generates control information for controlling a cassette (not comprising a second bag) serving as the external storage 300. The control information comprises, for example, information regarding the amount of banknotes to be accepted by the medium handling apparatus 200, that is, the amount of banknotes to be fed by the external storage 300.

In step S23, the processor 290 controls each component of the medium handling apparatus 200 to start accepting of banknotes from the discharge port 230. Specifically, the processor 290 causes the conveyor 240 to transport the banknotes received from the discharge port 230 to either the temporary holding unit 215 or the internal storage 270 to store the banknotes. The following steps S24 to S25 are executed while the medium handling apparatus 200 is accepting banknotes from the external storage 300.

In step S24, the processor 290 determines whether or not to complete the acceptance of banknotes from the external storage 300. The determination in step S24 may be made, for example, based on whether a preset number of banknotes for replenishment has been received.

When it is determined not to complete the acceptance in step S24 (step S24: N), the processing proceeds to step S25. When it is determined to complete the acceptance in step S24 (step S24: Y), the processing proceeds to step S26.

In step S25, the processor 290 continues the acceptance of banknotes from the external storage 300. After step S25, the processing returns to step S24.

In step S26, the processor 290 stops the acceptance of banknotes from the external storage 300. After step S26, for example, the processor 290 may make notification via the UI 216 that acceptance of the banknotes has been completed. This configuration allows the user to take the external storage 300 (after the replenishing the medium handling apparatus 200 with the banknotes is completed) out from the medium handling apparatus 200 to move the external storage.

### Exemplary Hardware Configuration

The above embodiments describe the configuration such that the processor 290 is a processor formed of electric circuitry, and the medium handling apparatus 200 comprising the processor 290 is an exemplary computer comprising a processor. The following describes an exemplary hardware configuration of a computer capable of achieving a medium handling apparatus of the present disclosure.

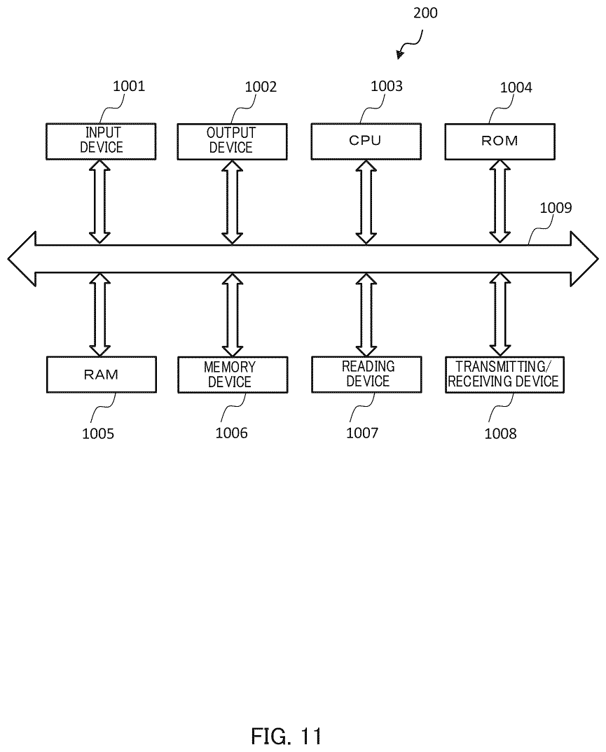

FIG. 11 illustrates an exemplary hardware configuration of the medium handling apparatus 200 serving as a computer.

The medium handling apparatus 200 comprises, as hardware configuration, an input device 1001, an output device 1002, a CPU 1003, a read only memory (ROM) 1004, a random access memory (RAM) 1005, a memory device 1006, a reading device 1007 that reads information from various recording media, and a transmitting/receiving device 1008. These devices are connected each other through a bus 1009.

The reading device 1007 reads programs for implementing the functions of the medium handling apparatus 200 from a recording medium with the programs recorded thereon, and stores the programs in the memory device 1006. Alternatively, the transmitting/receiving device 1008 communicates with a system device connected to the network, and stores the programs downloaded from the system device in the memory device 1006.

The CPU 1003 (corresponding to the processor 290 in FIG. 5) copies the programs stored in the memory device 1006 into the RAM 1005, and sequentially reads instructions comprised in the programs from the RAM 1005 and executes the instructions. The functions of the medium handling apparatus 200 are thus achieved.

### Variation

The above-described embodiment of the present disclosure merely illustrates one example of how the present disclosure may be implemented, and the present disclosure is not limited to the embodiment.

The above-described embodiment describes a configuration in which the first bag serving as the external storage is attached to the second attachment 282b, but the first bag serving as the external storage may be attached to the first attachment 282a. For example, a hook may be provided at the bottom of the first attachment 282a and the first bag can be hung from the hook.

1. A medium handling apparatus, comprising:
a conveyor that transports a medium;
recognition circuitry that recognizes the medium transported by the conveyor;
a safe that comprises an internal storage disposed therein, the internal storage being configured to store the medium;
a discharge port that performs discharging of the medium to an external storage, the external storage being disposed outside the safe and configured to store the medium; and
an attachment configured to connect the external storage with the discharge port, wherein the external storage is any one of a plurality of the external storages having external shapes different to each other.

2. The medium handling apparatus according to claim 1, wherein
the external storage is a cassette or a bag formed of a material softer than that of the cassette.

3. The medium handling apparatus according to claim 2, wherein:
the bag is a first bag; and
the first bag has a capacity greater than that of the cassette.

4. The medium handling apparatus according to claim 2, wherein
the external storage is the cassette comprising a second bag formed of a material softer than that of the cassette, the second bag being disposed inside the cassette.

5. The medium handling apparatus according to claim 4, wherein
the cassette comprises a stage that supports a bottom of the second bag.

6. The medium handling apparatus according to claim 5, wherein
the cassette further comprises:
a storage amount sensor that detects an amount of the medium discharged from the discharge port and stored in the second bag; and
a motor that moves the stage based on the amount detected.

7. The medium handling apparatus according to claim 5, wherein:
the cassette further comprises:
receiving circuitry that acquires control information from the medium handling apparatus; and
a motor that moves the stage in accordance with the control information,
wherein, in a state where the cassette is attached to the attachment, the medium handling apparatus generates the control information for moving the stage based on an accumulation mode and an amount of the medium discharged from the discharge port.

8. The medium handling apparatus according to claim 3, wherein
the attachment is configured to directly connect the discharge port with an opening of the first bag so that the medium discharged from the discharge port flows into the first bag through the opening of the first bag.

9. The medium handling apparatus according to claim 2, further comprising a processor that sets a maximum amount of the medium to be discharged from the discharge port to the external storage based on whether the external storage attached to the attachment is the cassette or the bag.

10. The medium handling apparatus according to claim 9, further comprising a user interface that generates information regarding the external shape of the external storage attached to the attachment, wherein the processor sets the maximum amount based on the information acquired from the user interface.

11. The medium handling apparatus according to claim 9, wherein the processor stops the discharging of the medium from the discharge port when the amount of the medium discharged from the discharge port reaches the maximum amount.

12. The medium handling apparatus according to claim 9, further comprising a user interface that receives an instruction to perform the discharging of the medium from the discharge port, wherein the processor starts the discharging when the user interface receives the instruction.

13. The medium handling apparatus according to claim 9, wherein
the processor controls a discharge speed of the medium from the discharge port based on whether the external storage attached to the attachment is the cassette or the bag.

14. A medium handling system, comprising:
a medium handling apparatus that handles a medium; and
an external storage that stores the medium, wherein
the medium handling apparatus comprises:
a conveyor that transports the medium;
recognition circuitry that recognizes the medium transported by the conveyor,
a safe that comprises an internal storage disposed therein, the internal storage being configured to store the medium;
a discharge port that discharges the medium to an external storage disposed outside the safe; and
an attachment configured to connect the external storage with the discharge port, the external storage being any one of a plurality of the external storages having external shapes different to each other.
